(19) United States
(12) Patent Application Publication
(10) Pub. No.: US 2025/0029503 A1
(43) Pub. Date: Jan. 23, 2025

(54) MANAGING UNCREWED AERIAL SYSTEM SERVICE SUPPLIER INSTANCES

(71) Applicant: Lenovo (Singapore) Pte. Ltd., New Tech Park (SG)

(72) Inventors: Emmanouil Pateromichelakis, Viersen (DE); Dimitrios Karampatsis, Ruislip (GB)

(21) Appl. No.: 18/709,011

(22) PCT Filed: Dec. 20, 2021
(86) PCT No.: PCT/EP2021/086908

§ 371 Date: May 9, 2024

Related U.S. Application Data
(63) Continuation-in-part of application No. PCT/EP2021/086908, filed on Dec. 20, 2021.

(30) Foreign Application Priority Data
Nov. 9, 2021 (GR) 20210100779

(51) Int. Cl. G08G 5/00; H04W 4/021; H04W 60/04

(52) U.S. Cl. CPC G08G 5/0043; G08G 5/0013; G08G 5/0069; H04W 4/021; H04W 60/04

(57) ABSTRACT

There is provided a method performed by a configuration unit, the configuration unit being communicatively coupled to a communication network and an Uncrewed Aerial System, UAS, the UAS including an Uncrewed Aerial Vehicle, UAV, and a UAV controller, UAV-C, the method comprising: receiving, for each of a plurality of UAV service suppliers, USS, information specifying a service area of that USS; obtaining UAS specific information, wherein the UAS specific information comprises a UAV registration area, a USS service requirement, or a combination thereof; and determining a mapping of the UAS specific information to one or more of the plurality of USSs based on the received USS information and the obtained UAS specific information.

### FIELD

The subject matter disclosed herein relates generally to the field of managing uncrewed aerial system service supplier instances. This document defines a method, a configuration unit, and a system.

### BACKGROUND

The following abbreviations are relevant in the field of the present document:
3GPP 3rd Generation Partnership Project
UAV Uncrewed Aerial Vehicle
USS UAS Service Supplier
UAS Uncrewed Aerial System
C2 Command and Control
UTM UAS Traffic Management
LUN Local USS Network
DNAI Data Network Access Identifier
UAV-C or UAVC UAV controller
SP/ASP Service Provider/Application Service Provider
AF Application Function
NF Network Function
NEF Network Exposure Function
SCEF Service Capability Exposure Function
FQDN Fully Qualified Domain Name
CAA Civil Aviation Administration
UUAA USS UAV Authorization/Authentication
UAES UAS Application Enabler Server
SEAL Service Enabler Architecture Layer
UAEC UAS Application Enabler Client
CAPIF Common API framework
UASASS UAS Application Specific Server
UASASC UAS Application Specific Client
DNN Data Network Name
FIMS Flight Information Management System

An Uncrewed Aerial System (UAS) is the combination of an Uncrewed Aerial Vehicle (UAV), and a UAV Controller (UAV-C). A UAV is an aircraft without a human pilot onboard-instead, in some cases, the UAV can be controlled from an operator via a UAV-C. The UAV-C can be a Remote Pilot in Command or the UAS operator. The UAV-C may be a remote autonomous system. The UAV also has some range of autonomous flight capabilities onboard. The communication requirements for the UAS cover both the Command and Control (C2), and uplink and downlink data to/from the UAS components towards both a serving 3GPP network and the network servers.

A USS is an entity that assists UAS Operators with meeting UAS Traffic Management (UTM) operational requirements that enable safe and efficient use of airspace. A USS acts as a communications bridge between federated UTM actors to support Operators' abilities to meet the regulatory and operational requirements for UAS operations and provides the Operator with information about planned operations in and around a volume of airspace so that Operators can ascertain the ability to safely and efficiently conduct a mission.

### SUMMARY

There is a need for methods and apparatuses to manage USS instances.

Disclosed herein are procedures for managing uncrewed aerial system service supplier instances. Said procedures may be implemented by apparatus, systems, methods, or computer program products.

There is provided a method performed by a configuration unit. The configuration unit is communicatively coupled to a communication network and an Uncrewed Aerial System, UAS, the UAS including an Uncrewed Aerial Vehicle, UAV, and a UAV controller, UAV-C. The method comprises receiving, for each of a plurality of UAV service suppliers, USS, information specifying a service area of that USS. The method further comprises obtaining UAS specific information, wherein the UAS specific information comprises a UAV registration area, a USS service requirement, or a combination thereof. The method further comprises determining a mapping of the UAS specific information to one or more of the plurality of USSs based on the received USS information and the obtained UAS specific information.

The determined mapping of the UAS specific information to one or more of the plurality of USSs tends to provide improved management of USS instances. In particular, the determined mapping may be used to facilitate handover from one USS instance to another of a UAV in flight. The determining of a mapping may comprise selecting one or more of the plurality of USSs to supply one or more services specified by the USS service requirement to the UAV as the UAV flies within the UAV registration area, the selecting based upon the received USS information and the obtained UAS specific information.

The information specifying the service areas of the USSs may be received from an application unit, the application unit being an application unit selected from the group of application units consisting of: a USS, a UAS Traffic Management module, the UAV, the UAV-C, a UAS application specific server, and a UAS operator.

The information specifying the service area of a USS may comprise one or more of the group consisting of: information specifying a geographical extent for the service supplied by that USS; information specifying a geographical extent for the service supplied by that USS within a registration area of the UAV; information specifying a time period during which a service is supplied by that USS; information specifying a time period during which a service is supplied by that USS within a registration area of the UAV; and information specifying a network topology for that USS.

The method may further comprise configuring a plurality of user-plane communication paths for the UAS, based on the determined mapping of the UAS to the plurality of USSs and the information specifying the service areas of the USSs. Each user-plane communication path may comprise a Data Network Access Identifier, DNAI. The configuration of a plurality of user-plane communication paths for the UAS tends to facilitate a smooth handover of a UAV in flight from one USS instance to another.

The method may further comprise configuring one or more policies for the UAS based on the mapping of the UAS to the plurality of USSs and the information specifying the service areas of the USSs. The one or more policies may comprise one or more policies selected from the group of policies consisting of USS switching criteria, priorities for the USSs having overlapping service areas, and a primary USS for the UAS; and transmitting the one or more policies to the UAS and/or a control function of the communication network.

The method may further comprise transmitting the determined mapping to one or more network functions of the communication network and/or the UAS.

The determination of the mapping of the UAS to the plurality of USSs may be based on a planned and/or expected route of the UAV. The plurality of USSs may comprise one or more Local USS Networks, LUNs.

The method may further comprise using the service area of the USS networks to detect a trigger event for initiating a change of USS, and, responsive to detecting of the trigger event, when the UAV is communicating with a first USS, determining whether a second USS is available to provide a service to the UAV. The method may further include, responsive to determining that the second USS is available to provide a service to the UAV, sending a request for UAV handover to the second USS network.

The method may further comprise transmitting a command to the UAS, the command being a command to migrate to receiving one or more services from the second USS network.

The method may further comprise receiving confirmation that the UAV has handed over to the second USS network.

The configuration unit may be a unit selected from the group of units consisting of: an Uncrewed Aerial System Application Enabler Server (UAES), the UAES being a server that is remote from the UAS; the UAV-C; a Network Exposure Function; a Network Function; an Application Function; a Service Capability Exposure Function; and the UAV.

There is further provided a configuration unit, the configuration for communicating with a communication network and an Uncrewed Aerial System, UAS, the UAS including an Uncrewed Aerial Vehicle, UAV, the configuration unit comprising a receiver and a processor. The receiver is arranged to receive, for each of a plurality of UAV service suppliers, USS, information specifying a service area of that USS. the processor is arranged to obtain UAS specific information, wherein the UAS specific information comprises a UAV registration area, a USS service requirement, or a combination thereof. The receiver is further arranged to determine a mapping of the UAS to (one or more of) the plurality of USSs based on the received USS information and the obtained UAS information.

There is further provided a system comprising a configuration unit as described herein and an application unit. The configuration unit may be arranged to receive the information specifying the service areas of the USSs from the application unit; and the application unit may be an application unit selected from the group of application units consisting of a USS, a UAS Traffic Management module, the UAV, the UAV-C, a UAS application specific server, and a UAS operator.

There is further provided a method performed by a configuration unit. The configuration unit is communicatively coupled to a communication network and an Uncrewed Aerial System, UAS, the UAS including an Uncrewed Aerial Vehicle, UAV, and a UAV controller, UAV-C. The method comprises receiving, for each of a plurality of UAV service suppliers, USS, information specifying a service area of that USS. The method further comprises obtaining UAS specific information, wherein the UAS specific information comprises a UAV registration area, a USS service requirement, or a combination thereof. The method further comprises selecting one or more of the plurality of USSs based on the received USS information and the obtained UAS specific information.

The selecting may comprise selecting one or more of the plurality of USSs to supply one or more services specified by the USS service requirement to the UAV as the UAV flies within the UAV registration area. The selecting may be based upon the received USS information and the obtained UAS specific information.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for managing uncrewed aerial system service supplier instances will now be described, by way of example only, with reference to the accompanying drawings, in which:

FIG. 1 illustrates a plan view of the geographical extent of a plurality of USS instances;

FIG. 2 illustrates the placement of multiple USSs in different edge/cloud platforms;

FIG. 3 illustrates the logical 3GPP architecture for UAS support;

FIG. 4 illustrates a high-level architecture of an application layer functional model for supporting UAS;

FIGS. 5a and 5b are messaging diagrams illustrating respective examples of multi-USS support at a UAS enabler layer;

FIGS. 6a and 6b are messaging diagrams illustrating respective examples of network-based multi-USS configuration and switching;

FIG. 7 depicts a user equipment apparatus that may be used according to any of the examples presented herein;

FIG. 8 illustrates a network node that may be used for implementing the methods described herein; and

FIG. 9 illustrates a method performed by a configuration unit.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

The present disclosure generally relates to the field of managing uncrewed aerial system service supplier instances, and in particular addresses the provision of UAV application service continuity in scenarios when more than one USS instance (deployed in edge or cloud) of different service providers may be providing services during the UAV flight.

An Uncrewed Aerial System (UAS) is the combination of an Uncrewed Aerial Vehicle (UAV), and a UAV controller (who can be, for example, a Remote Pilot in Command or the UAS operator). A UAV is an aircraft without a human pilot onboard-instead, in some cases, the UAV can be controlled from an operator via the UAV controller. The UAV also has some range of autonomous flight capabilities. The communication requirements for the UAS cover both the Command and Control (C2), and uplink and downlink data to/from the UAS components towards both a serving 3GPP network and the network servers.

A USS is an entity that assists UAS Operators with meeting UTM operational requirements that enable safe and efficient use of airspace. A USS acts as a communications bridge between federated UTM actors to support Operators' abilities to meet the regulatory and operational requirements for UAS operations and provides the Operator with information about planned operations in and around a volume of airspace so that Operators can ascertain the ability to safely and efficiently conduct the mission. The volume of airspace may be defined as the airspace above a defined or specified geographical area. The volume of airspace may be defined by a maximum and/or minimum operational height.

### A USS may Provide:

Services that enable authorized UTM stakeholders to discover active USSs and their available services within the USS Network,
Services that provide the ability for vehicle owners to register data related to their UAS,
Services for USS registration,
Services for message security to ensure data is secured and exchanged only with the authorized users,
other value-added services to support UTM participants as market forces create opportunity to meet business needs.

In some scenarios, the USSs are constituents of USS networks. The term ‘USS Network’ is the amalgamation of USSs connected to each other, exchanging information on behalf of subscribed Operators. The USS Network shares operational intent data, airspace constraint information, and other relevant details across the network to ensure shared situational awareness for UTM participants.

Each USS could have several geographic areas and times for which they provide services. Each of these different areas is referred to as a “USS Instance” for that USS.

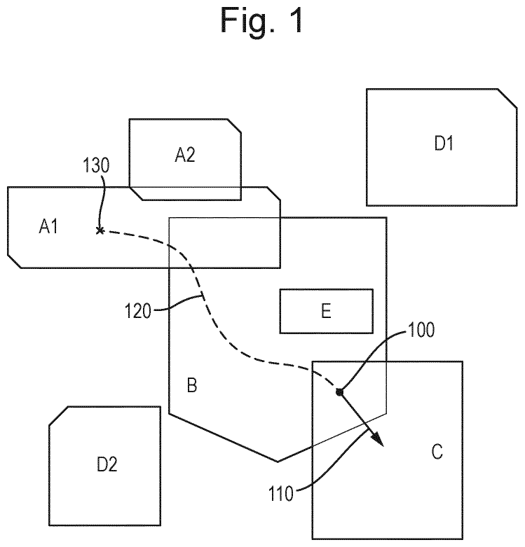

FIG. 1 illustrates a plan view of the geographical extent of a plurality of USS instances, A1, A2, B, C, D1, D2, and E. A Local USS Network (LUN) can be defined, by way of example, for USS Instance B. The LUN of USS instance B comprises USS instances A1, C, and E. The LUN of USS Instance C comprises only USS instance B. If an instance did not intersect any other instances, as with D1 or D2 for example, then its LUN is empty. It can also be noted that one USS may have two separate instances. In FIGS. 1, A1 and A2 are different instances from USS A; such instances may or may not overlap. For example, the two instances D1 and D2 of USS D do not overlap.

A UAV 100 is illustrated at a current position at a point that is in USS B and also covered by USS C. Vector 110 illustrates the UAV 100 velocity; the UAV 100 is approaching the boundary of USS B and is moving towards a central point of USS C. A dashed line illustrates the path 120 of the flight of the UAV 100 since the start of the flight at location 130 within USS A1.

In multi-USS scenarios, each USS may be physically located in a different cloud, and it is also possible that a USS is deployed at the edge. In such multi-USS scenarios, the interaction with the communication network for supporting a UAS session which requires the interaction to more than one USS e.g due to UAV mobility to different geographical area covered by different edge cloud, is preferably specified.

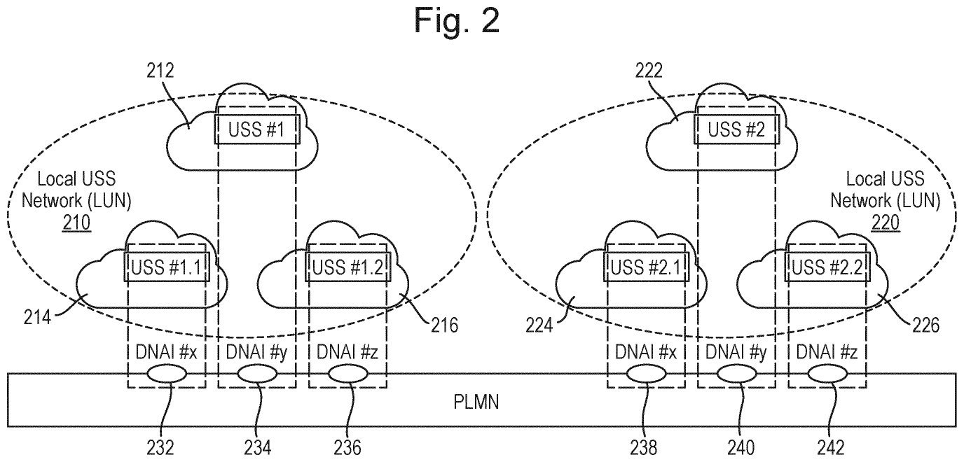

FIG. 2 illustrates placement of multiple USSs in different edge/cloud platforms. Two USSs are deployed in different edges/clouds and are clustered in different LUNs. A first LUN 210 comprises USS #1 212, USS #1.1 214, and USS #1.2 216. A second LUN 220 comprises USS #2 222, USS #2.1 224, and USS #2.2 226. Each USS instance (214, 212, 216, 224, 222, 226) has a respective Data Network Access Identifier (DNAI) (232, 234, 236, 238, 240 and 242). In such an arrangement the interaction of a UAV with 5GS may be via the different DNAIs. The UAV/UAV-C may be travelling to any location which it is allowed to, following the intended UAV route according to the UAS operator wishes, restrictions and/or requirements.

However, in such an arrangement the provisioning of a USS Address at the UAV may not be sufficient to capture the expected change and trigger migration to different USS. A LUN related information and address as well as the geographical area/addresses corresponding to USSs of the LUN may be needed at the UE side to understand a possible switching requirement.

Indeed, a UAV may require, while in flight, the switching of USS (i.e. switching from receiving one or more services from a first USS to receiving the one or more services (and/or other services) from a second USS different from the first USS). A switching of USS may be called a USS handover. Such switching may be done dynamically or even proactively to avoid service disruption. Conventional arrangements do not support how the network can be aware of the expected switching, to allow for dynamic traffic steering of UAS application traffic to different DNAI. In known arrangements, a USS switch might be implemented by way of the AMF triggering a new authorization, but such an approach has the problem that it does not allow for application service continuity while in flight.

Typically, different USSs don't necessarily provide the same services. Different USSs can be deployed by different Service Providers (SPs) which offer different services. In the case of switching USS while in flight, the UAS needs to be handed over from a source USS to a target USS which fulfils its service requirements and preferably offers similar performance as the source USS. The source USS is the current USS that the UAV uses, a USS handover results in the UAV switching USS from the source USS to the target USS.

The switching of USSs may adapt the LUN mapping, since the new LUN is a set of USSs in overlapping areas with respect to the target USS. As a result, the source USS needs to interact with different USSs about the notifications related to the UAS switch. Such a change will also impact the UAV and the UAS Operator side.

The LUN information will capture overlapping areas, and this would tend to reduce service loss by pro-actively migrating to the target USS before the UAV leaves the service area of the source USS. For example, as illustrated in FIG. 1, a UAV 100 is in USS B and in an area also covered by USS C. If it is determined that the UAV 100 is at the area covered by both Band C, and moving towards the boundary of B, to a part of C not covered by USS B, as illustrated by vector 110, then a USS handover from B to C may be initiated in-advance of the UAV 100 leaving USS B. In such an instance the network would support the handover by pro-actively steering traffic for the UAV to the new USS/DNAI (i.e., USS C).

Current assumptions in 3GPP SA2 (3GPP TS 23.502 v17.2.1) concerning a DNAI change are that the source Application Function (AF) checks whether it can serve the target DNAI. If it cannot and an AF instance change is needed, then the source AF determines the proper target AF for the target DNAI and performs the AF migration or handover. However, a mechanism is required to facilitate the determination of the target AF for the target DNAI.

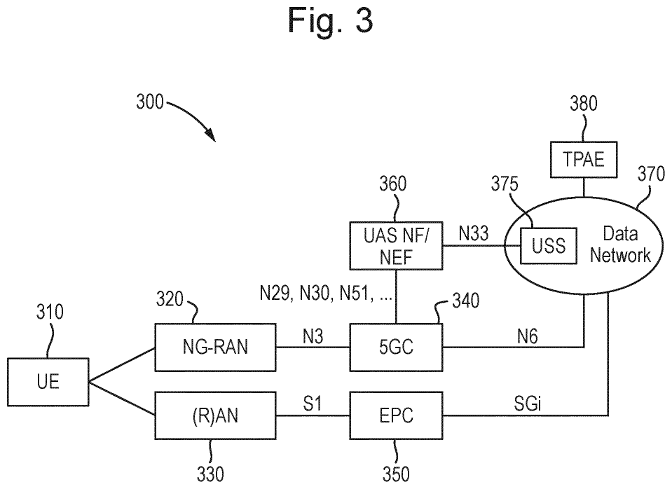

FIG. 3 illustrates logical 3GPP architecture for UAS support as described in 3GPP TS 23.256 v17.0.0, which specifies the authorization aspects for UAS connectivity, identification and tracking. The logical 5GS architecture for UAVs comprises a UE 310, which may be a UAV, an NG Radio Access Network (NG-RAN) 320, another Access Network (AN) 330 which may or may not be a Radio Access Network (RAN), a 5G Core (5GC) 340, an Evolved Packet Core (EPC) 350, a UAS Network Function (NF) or Network Exposure Function (NEF) 360, a data network 370, a USS 375 and a Third Party Authorized Entity (TPAE) 380. The UAV 310 communicates with at least one of the Access Networks 320 and 330 using a wireless communications protocol. NG-RAN 320 communicates with 5GC 340 using the N3 interface. (R) AN 330 communicates with EPC 350 using the S1 interface. 5GC 340 communicates with the UAS NF 360 using any one of the N29, N30 and N51 interfaces, for example. The USS 375 resides in the data network 370. The UAS NF 360 communicates with the USS 375 using an N33 interface. Additionally, the 5GC 340 communicates with the data network 370 using an N6 interface, and the EPC 350 interfaces with the data network 370 using the SGi interface. The USS 375 may communicate with an external entity such as TPAE 380 using the data network 370.

The new functionality described herein may reside in the UAS NF 360, which is supported by a NEF or a SCEF+NEF. UAS NF 360 provides external exposure of services to the USS 375. The UAS NF 360 makes use of existing NEF/SCEF exposure services for UAV 310 authentication/authorization, for UAV flight authorization, for UAV-UAVC pairing authorization, and related revocation; for location reporting, and control of QoS/traffic filtering for C2 communication. A dedicated NEF may be deployed to provide only the UAS NF 360 functionality, i.e. to support the UAS specific features/APIs and the NEF features/APIs that are specified for capability exposure towards the USS 375. To support a re-authentication request by the USS 375, the UAS NF 360 stores information as to whether the re-authentication is towards an AMF or SMF/SMF+PGW-C and the address of the serving AMF or SMF/SMF+PGW-C.

Furthermore, it is assumed that a UAV is registered with the USS either before connecting with the 3GPP system or using plain internet connectivity via the 3GPP system. Before registering for UAS services with the 3GPP system, the UAV shall be provisioned with a CAA-Level UAV Identity. One or more USS(s) may be present in a specific region and may manage UAVs over one or more 3GPP networks. It should be noted that according to 3GPP Release 17, it is envisaged that a UAV is served by single USS for the duration of the connectivity between the USS and the UAV.

In 3GPP TS 23.256 v17.0.0, the 5GC 340 optionally receives the USS 375 address or USS Fully Qualified Domain Name from the UAV 310 in addition to the CAA-level UAV ID, in order to discover the USS 372 on behalf of the UAV 310. The USS 375 address is provided at the UUAA registration from UE to AMF and also provided at the UUAA_MM procedure when AMF invokes the USS auth request to UAS NF.

Furthermore, in 3GPP SA6 an application layer functional model has been specified for supporting the UAS operation and integration with 5GS. The UAE server has functionalities for Location retrieving, QoS coordination and C2 selection/switching support.

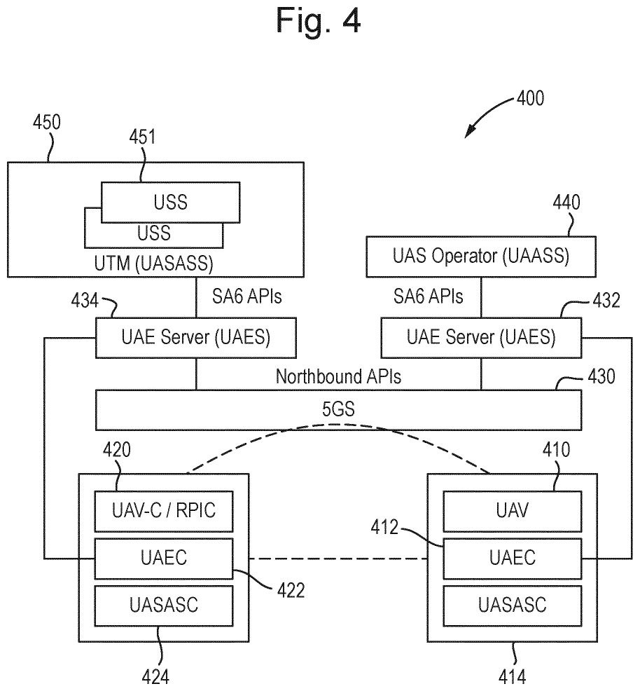

FIG. 4 illustrates the high-level architecture of an application layer functional model for supporting UAS. A UAV 410 has an associated UAS Application Enabler Client (UAEC) 412 and a UAS Application Specific Client (UASASC) 414. Similarly, a UAV Controller (UAV-C) 420 has an associated UAS Application Enabler Client (UAEC) 422 and a UAS Application Specific Client (UASASC) 424. A 5GS 430 provides wireless communications to the UAV 410 and UAV-C 420 and facilitates communication with respective UAE Servers (UAES) 432, 434. The communication may be facilitated by Northbound APIs. UAV 410 and UAV-C 420 may communicate via the 5GS 430 or directly by way of a direct radio connection. UAES 432 communicates with UAS Operator 440 which may reside at a UAS Application Specific Server (UASASS) and using UAE-server APIs (as defined in 3GPP TS 23.255 v 17.1.0). UAES 434 communicates with at least one USS 451 via a UAS Traffic Management (UTM) 450 which may be hosted in a UASASS. UAES 432, 434 may use UAE-server APIs to communicate with a respective UASASS 440, 450.

UAE Server 432 or 434 provides server side UAS application layer support functions as below:
performing group based QoS management for the UAS (i.e. pair of UAV and UAV-C) by using Service Enabler Architecture Layer APIs;
receiving C2 operation mode configuration from UAS application specific servers (e.g. USS/UTM) and further configuring the UAS UEs (i.e. UAV, UAV-C);
triggering C2 communication mode switching with the UAS Ues;
receiving and storing the selected C2 communication modes from the UAS Ues;
monitoring the real-time status of UAS Ues by using Service Enabler Architecture Layer APIs; and/or
supporting UAV application message communications between UAVs.

UAE Client 412, 422 supports interactions with the UAS application specific client(s). The UAE client provides the client side UAS application layer support functions, which include receiving and storing C2 operation mode configurations; selecting primary and secondary C2 communication modes based on the configurations; switching of C2 communication in emergency scenarios; and supporting UAV application message communication handling.

UAS Application Specific Server 440, 450 provides server-side functionality corresponding to the UAS applications (e.g. USS/UTM). The UAS application specific server utilizes the UAE server for the UAS application layer support functions. If CAPIF is supported, the UAS application specific server acts as CAPIF's API invoker as specified in 3GPP TS 23.222 v17.5.0. UASASS can be the UTM/USS or can be the UAS Operator (if this is different from the UAV pilot).

The UAS Application Specific Client 414, 424 provides client-side functionality corresponding to the UAS applications (e.g. Client interacting with USS/UTM). The UAS application specific client utilizes the UAE client for the UAS application layer support functions.

Broadly, the present disclosure provides a mechanism for supporting pro-active/dynamic USS switching for a UAS to facilitate to UAV mobility, via provisioning more granular and specific USS information to the UAS and the underlying communication network. Such functionality may be supported by the UAE layer (SA6) or via a Core Network (CN) function. The Core Network function may be any of a UAS NF, a NEF, and an SMF.

A Flight Information Management System (FIMS) at the UAS Traffic Management (UTM) configures the LUNs and in particular LUN #1 of USS1: USS2, USS3, LUN #2 of USS2: USS1, USS4. The FIMS provides this information via USSREQ_API (as specified in NASA/FAA specs on UTM). In overview the method proceeds as follows:
1. Before registering for UAS services with the 3GPP system, the UAV (and UAV-C) is provisioned with a CAA-Level UAV Identity and USS #1 Address/FQDN by UTM/UAS Operator, the USS #1 geographical area and time validity, the LUN identity and information (list of USSs overlapping with USS #1), the area of intersections/overlaps between two or more USSs (and their address) within the LUN.
2. UAV/UAV-C registers to 3GPP system (using also USS #1 ID and optionally the USS #1 information/geographical area/LUN information based on step 1)). Alternatively, UAEC of the UAV (or UAV-C) may also subscribe to UAE layer services after the registration to 3GPP system (using the USS #1 information/geographical area/LUN information based on step 1).
3. UAE layer/3GPP system provisions the UASASS (USS/UTM and/or UAS Operator) with the user-plane paths/DNAIs for all USSs within the LUN.
4. Optionally, the UAV/UAV-C UE also gets provisioned with policies/parameters for the list of services provided by all USSs within the LUN (e.g. QoS policies, radio parameters, etc.) as well as USS re-mapping/switching polices to identify under which criteria a USS remapping shall happen and priorities over USS remapping within the LUN. Such criteria consider the USS performance at a target area reaching a lower threshold, the availability of better performing USSs offering the same services, the target USS load/restrictions.
5. The UAV gets authorized for a flight and the flight starts.

After the above steps the method can follow one of the two following routes. In route one:
6. A trigger event is captured at network/server side, for example a UAV expected/predicted location deviation based on location tracking from LCS or SEAL LMS services (or from the UAV).
7. Core Network (CN) function/UAE server indicates that at the current area the USS #1 is intersecting with USS #2.
8. CN function/UAE server checks whether this offers the same service and asks for authorization from source/target USS and/or UAV.
9. Source/target USS and/or UAV send to CN function/UAE server an authorization and also the target USS LUN information with the geographical areas that other USSs cover.
10. CN function/UAE server (AF) checks whether it can serve the target DNAI corresponding to the target USS. If the AF instance change is needed, the AF determines the proper target AF for the target DNAI. The determination of the target AF for the target DNAI and the AF migration to the target AF is based on the target USS at the target area and the LUN information. CN function/UAE server then recommends the use of target USS to the UAV/UAV-C and/or the UTM/UAS operator to ask for confirmation before the AF migration (to make sure that it can provide coverage to the target area or decide to select another USS from the target LUN which can be more resilient to UAV mobility). Then the CN function/UAE server performs the AF migration to the target USS/AF. As result, a USS switch command is sent to the UAS and will tell the application in the UAV to establish a connection to a different USS address.
11. After the switch command, the UAV establishes a communication with the new USS (via user plane); to facilitate this the USS may trigger UAV re-authorization (e.g. assign a new CAA-level UAV ID, new security credentials for the user plane connection). In another alternative, that is SA2 specific, the target USS trigger USS re-authorization using the IP address of the UAV (i.e. no switch command to the UAV). During re-authorization the UAV obtains the new CAA-level UAV ID, USS address etc. The CN function/UAE server may also translate the new USS to a different DNAI and acting as AF may influence the traffic steering by requesting the change of the DNAI.

Alternative to route one immediately above, in route two the above-mentioned steps 1 to 5 are followed by:
a. A trigger event is captured at UE side indicating the location to the edge of the service area.
b. The UAV sends to 3GPP network/UAE server a request to change to target USS at the current area/time (based on the awareness that the USS #1 is intersecting with USS #2 at the current/expected location).
c. CN function/UAE server checks whether this offers the same service and asks for authorization from source/target USS.
d. Source/target USS sends to CN function/UAE server an authorization and also the target USS LUN information with the geographical areas that other USSs cover
e. Same as step 10.
f. Same as step 11.

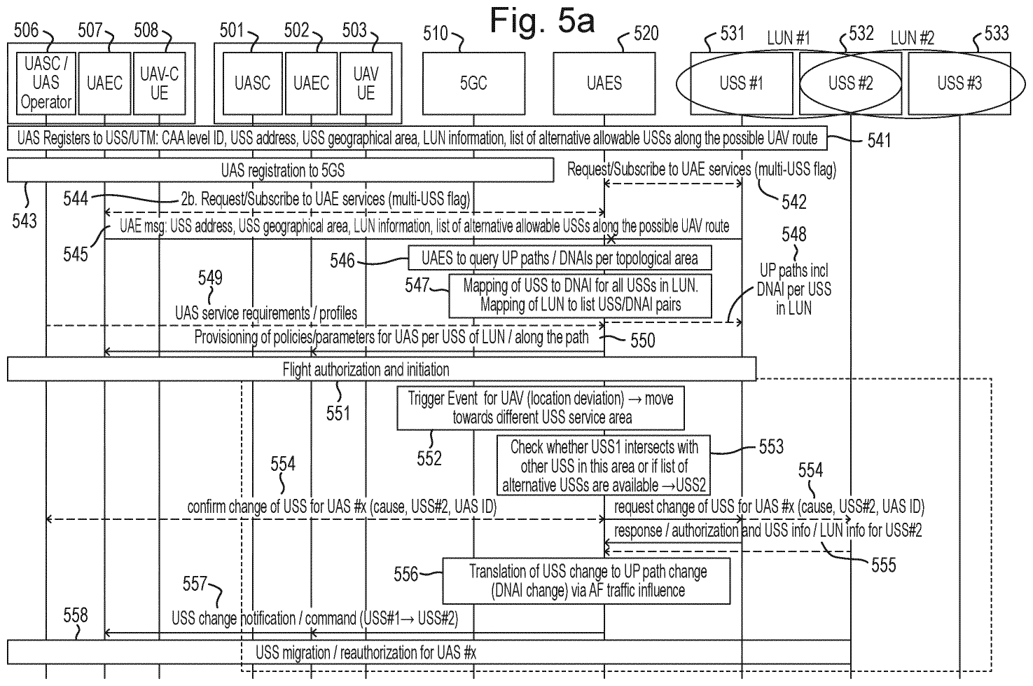

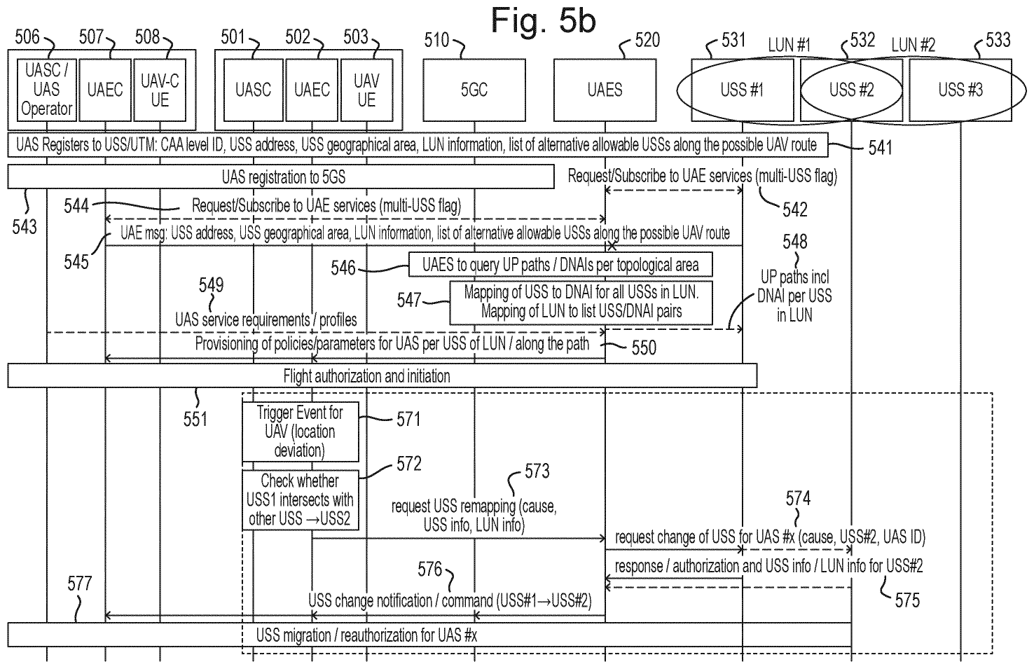

FIG. 5a is a messaging diagram illustrating an example of multi-USS support at a UAS enabler layer. The system illustrated in FIG. 5a comprises a UAV UE 503 and associated UASC 501 and UAEC 502. The system further comprises a UAV-C 508 UE 508 and associated UASC 506 and UAEC 507. The system further comprises a 5GC 510, a UAES 520, a USS #1 531, a USS #2 532, and a USS #3 533.

In this embodiment, the UAES 520 is a configuration unit, and each of the UAV 503 and UAV-C 508 have deployed a respective UAEC 502, 507.

At 541, before registering for UAS services with the 3GPP system, the UAV 503 (and UAV-C 508) is provisioned with a CAA-Level UAV Identity and USS #1 Address/FQDN by UTM/UAS Operator, the USS #1 geographical area and time validity, the LUN identity and information (list of USSs overlapping with USS #1 531), the area of intersections/overlaps between two or more USSs (and their address) within LUN. In this step, the UAE server 520 may play a role by providing the policies from UTM to UAV 503/UAV-C 508.

The UAS registers 543 to 5GS based on TS 23.256 and following the UAE layer service can start via two alternative ways, 542 or 544.

At 542, USS #1 531, or UTM acting as UASASS, requests/subscribes to receive the UAE server services. In such a subscription request, the USS #1 531 may provide one or more of: an indication that the UAS is expected to be operated in areas where multiple USSs are available (e.g. using a multi-USS flag), the USS ID and address of each USS in the are where the UAS is expected to operate, the UAV 503/UAV-C 508 ID or the CAA ID, the time validity for the subscription and the area of validity, the preferred slice ID (S-NSSAI/ENSI) for the UAS communication, and/or the level of exposure required for the northbound services/APIs. UAES 520 sends a response indicating a positive or negative result.

Alternative to step 542, at 544, the UAV-C 508 or RPIC or the UAS operator (if it is separate entity) may request/subscribe to receive the UAE server 520 services via UAEC 507 (UASC 506 sends a subscription request to UAEC 507 and UAEC 507 forwards that subscription request to UAES 520). In such subscription request, the UASC 506 may provide one or more of: an indication that the UAS is expected to be operated in areas where multiple USSs are available (e.g. using a multi-USS flag), the USS ID and address, the UAV 503/UAV-C 508 ID or the CAA ID, the UAEC ID for the UAV 503 and UAV-C 508, the time validity for the subscription and the area of validity, and/or the preferred slice ID (S-NSSAI/ENSI) for the UAS communication. UAES 520 sends a response to UAEC 507 indicating a positive or negative result.

At 545, the UAV 503 operator or the USS sends additional information after the subscription about the USS geographical area, the LUN of the USS, the list of the USSs within the LUN, the geographical area of other USSs, the topological area corresponding to USS and LUN, the expected missions and allowable areas/route where the UAV 503 can travel, the UAV 503 capabilities.

At 546, UAES 520 obtains the UP-path information for all DNs within its coverage. Such information may be obtained via user-plane (from UPF/global DN) or alternatively may query 5GC 510 (PCF/UDM via NEF) for the list of DNAIs corresponding to different authorized USSs for a particular area or for an area that covers an expected/allowable UAV 503 route. Such query request may indicate the USS address/AF ID, routing profile (for UAS app) and will require the UP information (e.g. DNAI, DNN, S-NSSAI) for multiple possible application locations (with the service area). 5GC 510 will then provide the list of the DNAIs for the application profile corresponding to different USSs together with the USS ID/address and optionally the topological area per USS (e.g. list of cells).

At 547, UAES 520 maps each USS (AF) with one or more DNAIs, for all USSs within the LUN. It may also map the USS to topological areas (cells). Then it also maps and stores all pairs of <USS x, DNAI y> per LUN or for the areas of interest for the UAV 503 (e.g. based on the allowable routes).

At 548, UAES 520 optionally provides UP-path information per USS to the source USS and optionally to the UAV 503 Operator/UAV-C 508 (since source USS may not be aware of the other USSs). It shall be possible that UAES 520 requests approval from the target USSs to provide the details prior sending the UP information of other USSs.

At 549, UAS Operator (can be the app at the UAV-C 508 or a server) provides the service profiles to UAES 520 (via UAEC) for the UAV 503 based on the UAV 503 operations/expected capabilities (e.g. commercial drones, PS drones).

At 550, UAES 520 provisions the UAV 503/UAV-C 508 with policies/parameters about the communication via 5GS (for both PC5/Uu). Such policies/parameters can be like what is defined for V2X (TS 23.287) however the additional parameters may relate to different policies per USS (including alternative USSs/LUNs) and policies related to whether to migrate to different USS in case of overlapping coverage/inadequate support of serving USS. These policies may include also priorities of USSs if more than one USS is available in target area.

At 551, UAV 503 flight is authorized, and flight starts/UAV 503-UAV 503C are both connected/establish PDU sessions to 5GS.

The above steps are the same for FIGS. 5a and 5b. FIG. 5a illustrates a first arrangement wherein steps 541 to 551 are followed by the following.

At 552, UAES 520 tracks the location of the UAV 503, by subscribing to 5GC 510/LMF or by subscribing to SEAL or via regularly requesting the actual/expected/predicted location of the UAV 503. UAES 520 generates a trigger event indicating that the UE moves to an area where the USS is overlapping with other USS or the USS is not supported.

At 553, if it is an overlap, the UAES 520 checks whether the performance of serving USS is impacted (by requesting QoS sustainability analytics, or by requesting DN/USS performance analytics for the target area) or if the serving USS is not supported at target area, checks what is the best available USS and whether this can provide the same services. The criteria for the best available USS are mainly the location of the UAV 503, but it can be also the priorities of the USS (based on the policies) at the target area and the capabilities (services) provided by the target USS to be equivalent.

At 554, UAES 520 sends to source USS (or target USS) a request/confirmation request message indicating the requirement for a USS migration for the UAS and provides the target USS or just an indication of a need for change. This message may comprise the UAS ID, the serving and target USS address, the cause for the change, the expected time/location of change. Such message may additionally or alternatively be sent to the UAS Operator (UAV-C 508 or UAS Operator as server side) or UTM to confirm the transition to target USS.

At 555, involved USSs authorize the migration with the support of UTM/FIMS and provide a response which indicates the result (success/failure/negotiation by propose a different USS), and provides the LUN/list of USS information for the target USS

At 556, UAES 520 translates this to a UP path change and interacts with SMF via NEF as AF for influence UP path (switching to target DNAI). In particular UAE server (acting as AF) checks whether it can serve the target DNAI corresponding to the target USS based on the mapping of USS to DNAI which was performed in step 3b. If the AF instance change is needed, the AF determines the proper target AF for the target DNAI. The determination of the target AF for the target DNAI and the AF migration to the target AF is based on the confirmed target USS at the target area. Then CN function/UAE server performs the AF migration to the target USS/AF.

At 557, UAES 520 also sends the USS remapping notification/command to the UAS (UAV 503 and/or UAV-C 508) via UAEC and then at 558 the USS migration is executed.

FIG. 5b illustrates a second arrangement alternative to steps 542 to 557 above wherein the steps of 541 to 551 are the same as FIG. 5a, but in contrast to the rest of FIG. 5a, FIG. 5b proceeds as follows.

At 571, UAV 503/UASC captures a location deviation/mobility event towards an area where the USS is overlapping with other USS or the USS is not supported.

At 572, if there is an overlap, the UAEC checks whether the performance of serving USS will be impacted or if the serving USS is not supported at target area, checks what is the best available USS and whether this can provide the same services (based on the pre-configuration of list of USSs). The criteria for the best available USS are mainly the location of the UAV 503, but it can be also the priorities of the USS (based on the policies) at the target area and the capabilities (services) provided by the target USS to be equivalent.

At 573, UAEC sends to UAES 520 a request/notification for switching USS with the exact target USS or just indicating that the serving USS is not (is not expected to be) available or preferred.

At 574, UAES 520 sends to source USS (or target USS) a request/confirmation request message indicating the requirement for a USS migration for the UAS and provides the target USS or just a need for change. This message includes the UAS ID, the serving and target USS address, the cause for the change, the expected time/location of change. Such message may also (or alternatively) be sent to the UAS Operator (UAV-C 508 or UAS Operator as server side) or UTM to confirm the transition to target USS.

At 575, involved USSs authorize the migration from one USS to another with the support of UTM/FIMS and provides a response to UAES 520 which indicates the result (success/failure/negotiation by propose a different USS), and provides the LUN/list of USS information for the target USS.

At 576, UAES 520 translates the received response message to a UP path change and interacts with SMF via NEF as AF for influence UP path (switching to target DNAI). In particular, UAE server (UAES) 520 (acting as AF) checks whether it can serve the target DNAI corresponding to the target USS based on the mapping of USS to DNAI which was performed in step 3b. If the AF instance change is needed, the AF determines the proper target AF for the target DNAI. The determination of the target AF for the target DNAI and the AF migration to the target AF is based on the confirmed target USS at the target area. Then CN function/UAE server performs the AF migration to the target USS/AF.

At 577, UAES 520 also sends the USS remapping response/command to the UAS (UAV 503 and/or UAV-C 508) via UAEC and then the USS migration is executed in step 577.

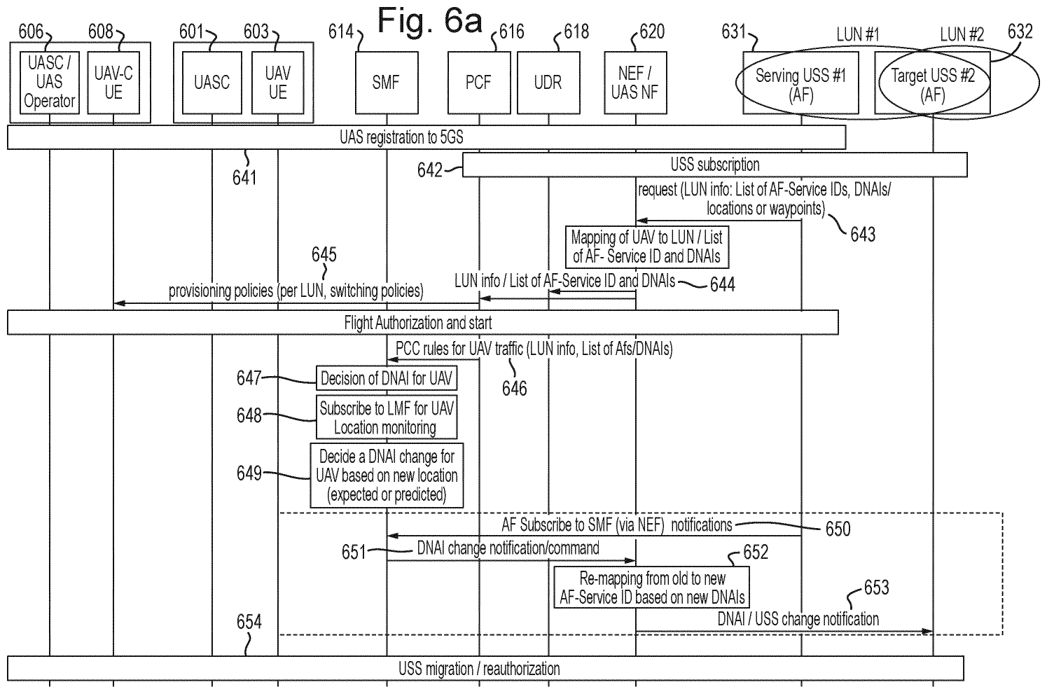

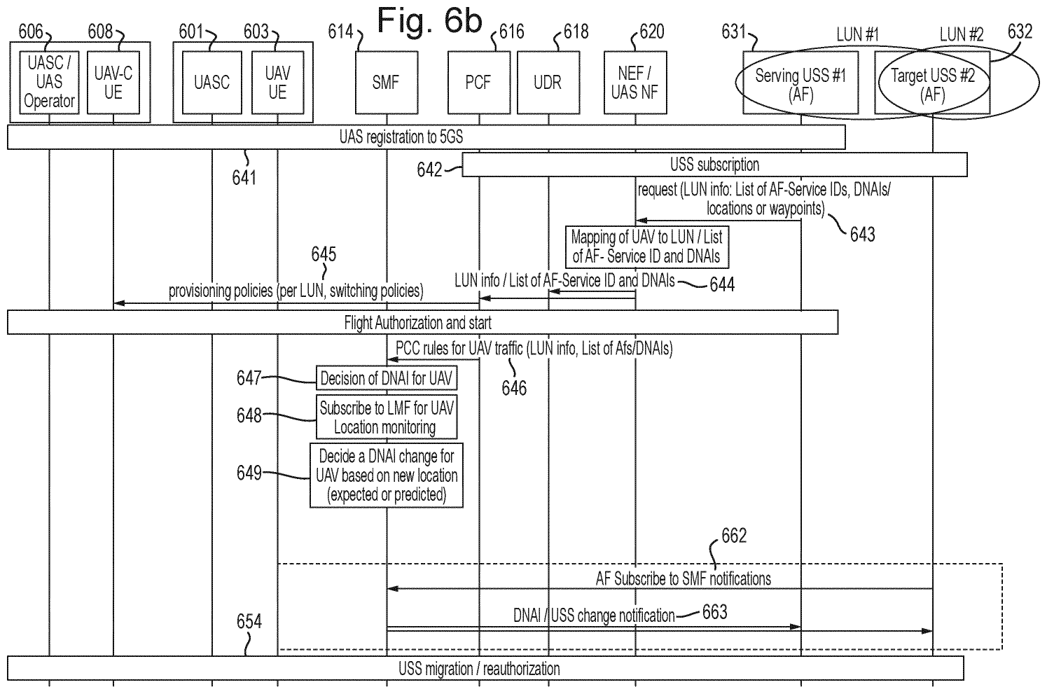

FIG. 6a is a messaging diagram illustrating an example of network-based multi-USS configuration and switching. The system of FIG. 6a comprises a UASC 606, a UAV-C 608, a UASC 601, a UAV UE 603, a Session Management Function (SMF) 614, a Policy Control Function (PCF) 616, a Unified Data Repository 618, a UAS Network Function (NF) or Network Exposure Function (NEF) 620, USS #1 631 and USS #2 632. In the example of a USS handover, migration, or re-mapping presented below USS #1 631 is the source USS and USS #2 632 is the target USS.

At 641, the UAS registers to 5GS based on TS 23.256, this can be done according to either of the steps 542 or 544 discussed above in connection with FIG. 5a.

At 642, USS #1 initially subscribes to NEF 620 with its own AF-service-ID and optionally the corresponding DNAI list. Such subscription is not bound to specific UAV or could be for a specific application profile. Additionally, other USSs may also subscribe independently with their own AF-service-ID and optionally the corresponding DNAI list. In this subscription the USS address/FQDN and optionally DNAI, geographical areas are sent to the 5GC.

At 643, USS #1 or UTM or UAS Operator (AF) sends an AF request to UAS NF/NEF 620 using a LUN ID and a List of pairs of <AF-Service-ID, DNAIs or geographical/topological areas> for the UAS (each AF-Service-ID corresponds to different USS within the LUN). If USS #1 is aware of the IP address of the UAV 603 (i.e. a UAV that has an ongoing session with the USS or C2 communication) the USS includes the IP address of the UAV 603.

At 644, UAS NF/NEF 620 sends to PCF 616 via UDR 618 a message including the list of pairs of <AF-Service-ID, DNAIs or geographical/topological areas> for the UAS. UAS NF/NEF 620 may also translate the mapping to DNAIs instead of areas if this information is not at the AF request. PCF 616 groups the list of AF-Service-IDs and the list of DNAIs for the target UAV. If the NEF 620 receives the IP address of the UAV the NEF 620 discovers the PCF 616 serving the UAV (which may be done based on the IP address) and sends the list of AF-Service-ID and corresponding DNAI(s) directly to the PCF 616.

At 645, PCF 616 sends policies for the UAS to UAV-C 608 before the flight. These policies include the per USS provisioning policies/parameters for all USSs within the LUN and USS switching policies (under which criteria/thresholds to trigger a switching at the UAV) and priorities among USSs (if more than one USS cover overlapping areas). The UAV flight is then authorized and started.

At 646, PCF 616 sends the traffic rules to SMF 614 for the UAV for multiple USSs (list of AF-Service-IDs). SMF 614 may group the list of AF-Service-IDs and the list of DNAIs for the target UAV PDU session.

At 647, SMF 614 decides the DNAI for the UAV based on UAV location and based on consuming DN performance analytics (if USS has access to more than one DNAI).

At 648, SMF 614 subscribes to LMF/AMF for LCS monitoring.

At 649, SMF 614 captures a DNAI change for UAV (based on location monitoring).

The above steps are the same for FIGS. 6a and 6b. FIG. 6a illustrates a first arrangement wherein steps 641 to 649 are followed by the following.

At 650, the AF subscribes to a notification from the SMF 614 (via the NEF 620) for DNAI change. This subscription is a group message. The AF subscribes with a list of AF-Service-IDs and corresponding DNAI.

At 651, SMF 614 sends to NEF 620/UASNF the captured DNAI change.

At 652, NEF 620/UASNF checks whether it can serve the target DNAI corresponding to the target USS based on the mapping of USS to DNAI which was performed in step 2. If the AF instance change is needed, the AF determines the proper target AF for the target DNAI. The determination of the target AF for the target DNAI and the AF migration to the target AF is based on the confirmed target USS at the target area (in case of confirmation needed, the NEF 620/UASNF requests confirmation from the source/target USS or UTM first).

At 653, then UAS NF/NEF 620 performs the AF migration to the target USS/AF. More specifically, NEF 620 updates for the UAV application the old AF-service-ID to the new AF-service-ID (for target USS). NEF 620 may send a trigger request/notification to one or both AFs (for both USSs) to indicate the switching of USS.

At 654, the USS migration is executed.

FIG. 6b illustrates a second arrangement wherein the steps of 641 to 649 are the same as FIG. 6a, but in contrast to the rest of FIG. 6a, FIG. 6b proceeds as follows.

At 662, the AF subscribes to notification to the SMF 614 for DNAI change. This subscription is a group message. The AF subscribes with a list of AF-Service-IDs and corresponding DNAI.

At 663, the SMF 614 is aware of the list AF-Service-IDs within LUN and the policies/priorities for the USS re-selection sends to the involved AFs (serving and target) the change of DNAI for the UAV. SMF 614 may check whether it can serve the target DNAI corresponding to the target USS based on the mapping of USS to DNAI which was performed in step 2. If the AF instance change is needed, the AF determines the proper target AF for the target DNAI. The determination of the target AF for the target DNAI and the AF migration to the target AF is based on the confirmed target USS at the target area.

At 654, USS2 performs re-authorization based on current procedures as in TS 23.256.

This document describes a new capability for supporting dynamic/pro-active in-flight adaptation of USS without impacting the UAV performance/connectivity. It also describes the use and exchange of LUN information and USS geographical areas at 5GS/enabler layer to support dynamic/proactive in-flight adaptation. AF-to-AF interaction via 5GS is provided to support dynamic translation of UAV mobility events to series of traffic steering of UP paths/DNAIs. SMF/PCF/NEF enhancements allow for grouping AF-Service-IDs and mapping to DNAIs per group of USSs/LUN, and to exposing notifications to all involved AFs corresponding to the UAV applications.

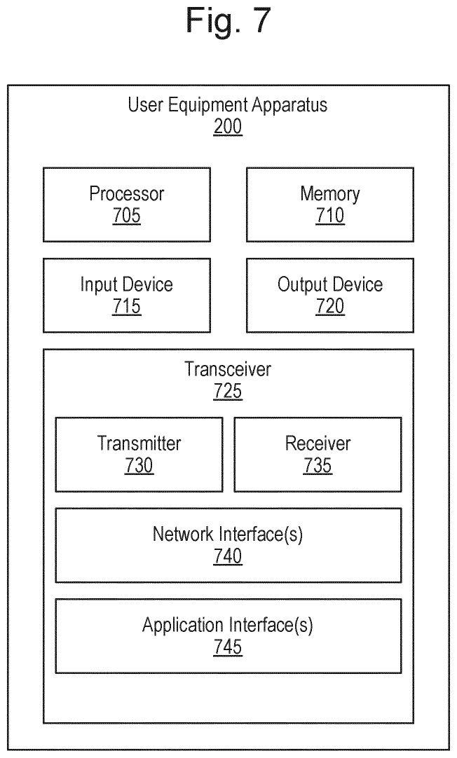

FIG. 7 depicts a user equipment apparatus 700 that may be used according to any of the examples presented herein. The user equipment apparatus 700 may be the UE 310, the UAV 410, the UAV-C 420, the UAV UE 503, the UAV-C UE 508, the UAV UE 603, and the UAV-C UE 608. The user equipment apparatus 700 is used to implement one or more of the solutions described above. The user equipment apparatus 700 may also include a processor 705, a memory 710, an input device 715, an output device 720, and a transceiver 725. Where the UE 700 is a UAV, the UE 700 also has features for conducting flight which may include a propulsion system, a flight control system and one or more cameras.

The input device 715 and the output device 720 may be combined into a single device, such as a touchscreen. The user equipment apparatus 700 may not include any input device 715 and/or output device 720. The user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. The transceiver 725 may communicate with one or more cells (or wireless coverage areas) supported by one or more base units. The transceiver 725 may be operable on unlicensed spectrum. Moreover, the transceiver 725 may include multiple UE panels supporting one or more beams. Additionally, the transceiver 725 may support at least one network interface 740 and/or application interface 745. The application interface(s) 745 may support one or more APIs. The network interface(s) 740 may support 3GPP reference points, such as Uu, N1, PC5, etc. Other network interfaces 740 may be supported, as understood by one of ordinary skill in the art.

The processor 705 may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), or similar programmable controller. The processor 705 may execute instructions stored in the memory 710 to perform the methods and routines described herein. The processor 705 is communicatively coupled to the memory 710, the input device 715, the output device 720, and the transceiver 725.

The processor 705 may control the user equipment apparatus 700 to implement the above-described UE behaviors. The processor 705 may include an application processor (also known as “main processor”) which manages application-domain and operating system (“OS”) functions and a baseband processor (also known as “baseband radio processor”) which manages radio functions.

The memory 710 may be a computer readable storage medium. The memory 710 may include volatile computer storage media. For example, the memory 710 may include a RAM, including dynamic RAM (“DRAM”), synchronous dynamic RAM (“SDRAM”), and/or static RAM (“SRAM”). The memory 710 may include non-volatile computer storage media. For example, the memory 710 may include a hard disk drive, a flash memory, or any other suitable non-volatile computer storage device. The memory 710 may include both volatile and non-volatile computer storage media.

The memory 710 may store data related to implement a traffic category field as describe above. The memory 710 may also store program code and related data, such as an operating system or other controller algorithms operating on the apparatus 700.

The input device 715 may include any known computer input device including a touch panel, a button, a keyboard, a stylus, a microphone, or the like. The input device 715 may be integrated with the output device 720, for example, as a touchscreen or similar touch-sensitive display. The input device 715 may include a touchscreen such that text may be input using a virtual keyboard displayed on the touchscreen and/or by handwriting on the touchscreen. The input device 715 may include two or more different devices, such as a keyboard and a touch panel.

The output device 720 may be designed to output visual, audible, and/or haptic signals. The output device 720 may include an electronically controllable display or display device capable of outputting visual data to a user. For example, the output device 720 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

The output device 720 may include one or more speakers for producing sound. For example, the output device 720 may produce an audible alert or notification (e.g., a beep or chime). The output device 720 may include one or more haptic devices for producing vibrations, motion, or other haptic feedback. All, or portions, of the output device 720 may be integrated with the input device 715. For example, the input device 715 and output device 720 may form a touchscreen or similar touch-sensitive display. The output device 720 may be located near the input device 715.

The transceiver 725 communicates with one or more network functions of a mobile communication network via one or more access networks. The transceiver 725 operates under the control of the processor 705 to transmit messages, data, and other signals and also to receive messages, data, and other signals. For example, the processor 705 may selectively activate the transceiver 725 (or portions thereof) at particular times in order to send and receive messages.

The transceiver 725 includes at least transmitter 730 and at least one receiver 735. One or more transmitters 730 may be used to provide UL communication signals to a base unit of a wireless communications network. Similarly, one or more receivers 735 may be used to receive DL communication signals from the base unit. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. The transceiver 725 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

One or more transmitters 730 and/or one or more receivers 735 may be implemented and/or integrated into a single hardware component, such as a multi-transceiver chip, a system-on-a-chip, an Application-Specific Integrated Circuit (“ASIC”), or other type of hardware component. One or more transmitters 730 and/or one or more receivers 735 may be implemented and/or integrated into a multi-chip module. Other components such as the network interface 740 or other hardware components/circuits may be integrated with any number of transmitters 730 and/or receivers 735 into a single chip. The transmitters 730 and receivers 735 may be logically configured as a transceiver 725 that uses one more common control signals or as modular transmitters 730 and receivers 735 implemented in the same hardware chip or in a multi-chip module.

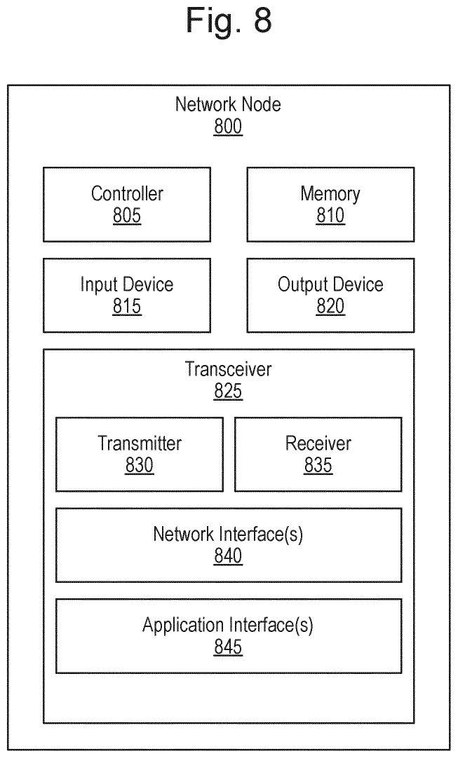

FIG. 8 illustrates a network node 800 that may be used for implementing the methods described herein. The network node 800 may be any one of the network nodes described herein, and in particular could be a configuration unit, a Core Network function, the UAS NF 360, the UAES 434, the UAES 432, the UAES 520, the NEF 620. The network node 800 may include a controller 805, a memory 810, an input device 815, an output device 820, and a transceiver 825.

The input device 815 and the output device 820 may be combined into a single device, such as a touchscreen. The network node 800 may not include any input device 815 and/or output device 820. The network node 800 may include one or more of: the controller 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The controller 805 may include any known controller capable of executing computer-readable instructions and/or capable of performing logical operations. For example, the controller 805 may be a microcontroller, a microprocessor, a CPU, a GPU, an auxiliary processing unit, a FPGA, or similar programmable controller. The controller 805 may execute instructions stored in the memory 810 to perform the methods and routines described herein. The controller 805 is communicatively coupled to the memory 810, the input device 815, the output device 820, and the transceiver 825.

The memory 810 may be a computer readable storage medium. The memory 810 may include volatile computer storage media. For example, the memory 810 may include a RAM, including dynamic RAM (“DRAM”), synchronous dynamic RAM (“SDRAM”), and/or static RAM (“SRAM”). The memory 810 may include non-volatile computer storage media. For example, the memory 810 may include a hard disk drive, a flash memory, or any other suitable non-volatile computer storage device. The memory 810 may include both volatile and non-volatile computer storage media.

The input device 815 may include any known computer input device including a touch panel, a button, a keyboard, a stylus, a microphone, or the like. The input device 815 may be integrated with the output device 820, for example, as a touchscreen or similar touch-sensitive display. The input device 815 may include a touchscreen such that text may be input using a virtual keyboard displayed on the touchscreen and/or by handwriting on the touchscreen. The input device 815 may include two or more different devices, such as a keyboard and a touch panel.

The output device 820 may be designed to output visual, audible, and/or haptic signals. The output device 820 may include an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the network node 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

The output device 820 may include one or more speakers for producing sound. For example, the output device 820 may produce an audible alert or notification (e.g., a beep or chime). The output device 820 may include one or more haptic devices for producing vibrations, motion, or other haptic feedback. All, or portions, of the output device 820 may be integrated with the input device 815. For example, the input device 815 and output device 820 may form a touchscreen or similar touch-sensitive display. The output device 820 may be located near the input device 815.

The transceiver 825 includes at least transmitter 830 and at least one receiver 835. One or more transmitters 830 may be used to communicate with the UE, as described herein. Similarly, one or more receivers 835 may be used to communicate with network functions in the PLMN and/or RAN, as described herein. Although only one transmitter 830 and one receiver 835 are illustrated, the network node 800 may have any suitable number of transmitters 830 and receivers 835. Further, the transmitter(s) 830 and the receiver(s) 835 may be any suitable type of transmitters and receivers.

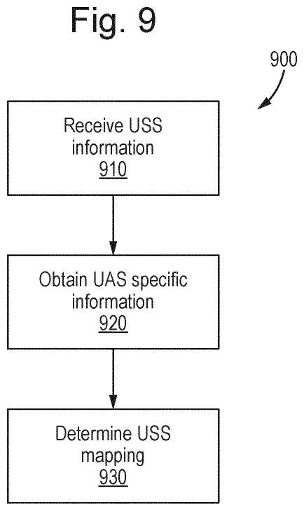

FIG. 9 illustrates a method performed by a configuration unit 900. The configuration unit 900 may comprise UAS NF 360, the UAES 434, the UAES 432, the UAES 520, the NEF 620, or the network node 800. The configuration unit 900 is communicatively coupled to a communication network and an Uncrewed Aerial System (UAS) the UAS including an Uncrewed Aerial Vehicle (UAV) and a UAV controller (UAV-C). The method comprises receiving 910, for each of a plurality of UAV service suppliers, USS, information specifying a service area of that USS. The method further comprises obtaining 920 UAS specific information, wherein the UAS specific information comprises a UAV registration area, a USS service requirement, or a combination thereof. The method further comprises determining 930 a mapping of the UAS specific information to one or more of the plurality of USSs based on the received USS information and the obtained UAS specific information.

The determined mapping of the UAS specific information to one or more of the plurality of USSs tends to provide improved management of USS instances. In particular, the determined mapping may be used to facilitate handover from one USS instance to another of a UAV in flight.

In some alternatives, the determining a mapping may comprise selecting one or more of the plurality of USSs based on the received USS information and the obtained UAS specific information.

Indeed, there is also provided a method performed by a configuration unit, the configuration unit being communicatively coupled to a communication network and an Uncrewed Aerial System, UAS, the UAS including an Uncrewed Aerial Vehicle, UAV, and a UAV controller, UAV-C, the method comprising: receiving, for each of a plurality of UAV service suppliers, USS, information specifying a service area of that USS; obtaining UAS specific information, wherein the UAS specific information comprises a UAV registration area, a USS service requirement, or a combination thereof; selecting one or more of the plurality of USSs based on the received USS information and the obtained UAS specific information.

The configuration unit 900 determines a mapping of the UAS specific information to one or more of the plurality of USSs. This tends to allow for a new capability for supporting dynamic and pro-active in-flight adaptation of USS while maintain UAV connectivity. Further, the collection of the USS information and USS geographical areas at the configuration unit 900 tends to support both dynamic and proactive in-flight adaptation, in particular USS handover in-flight. Further, the configuration unit 900 tends to facilitate AF-to-AF interaction via 5GS, which supports dynamic translation of UAV mobility events to a series of traffic steering of user plane paths and DNAIs. It should be further noted that the configuration unit 900 tends to facilitate SMF/PCF/NEF enhancements to allow for grouping AF-Service-IDs and mapping to DNAIs per group of USSs/LUN, and to exposing notifications to all involved AFs corresponding to the UAV applications.

Determining a mapping may comprise selecting one or more of the plurality of USSs to supply one or more services specified by the USS service requirement to the UAV as the UAV flies within the UAV registration area, the selecting based upon the received USS information and the obtained UAS specific information.

The UAV registration area may be a space in which the UAV intends to operate, and/or is permitted allowed to operate. The space in which the UAV intends to operate may comprise a predetermined route. The UAV may fly along the predetermined route. The space may be defined by an area of ground and a volume above that area of ground. The volume may be constrained by a minimum and a maximum operating height. The UAV registration area may specify a volume of airspace or a physical region in which the UAV is registered to operate in, and/or a geographical area over which the UAV is registered to operate. The UAV registration area may comprise the registration area which is the authorized area where the UAV is allowed to fly, and is provided by a regulatory authority such as the UAS Traffic Management or a flight aviation authority (such as, for example Civil Aviation Authority (UK) or Federal Aviation Authority (US)). Alternatively, the UAV registration area may be defined by the UE registration area for the public land mobile network, PLMN, where the UAS is allowed to communicate based on prior service level agreement with the PLMN operator.

The USS service requirement is a definition of the services that the UAS requires during the intended operation of the UAV. The USS offers a variety of services which can be seen as tools to be used by the UAS operator to monitor the airspace, execute safe missions, and store operational data. The USS services can relate to discovery/exploration of airspace conditions pertaining the UAV flight, supporting UAV flight planning and in-flight support e.g. for providing real-time alerts. Different services may be available in different USS instances, and the USS service requirements may be both the variety of services that the USS offers as well as the service key performance requirements for each USS service, for providing these services over the communication network. Such requirements may include a minimum communication bandwidth in an uplink or downlink direction, or both. The service definitions may include a maximum communication latency in an uplink or downlink direction, or both. The service requirement may include a location provision requirement wherein the UAV is sent its location, the location provision requirement may include a minimum location accuracy.

The information specifying the service areas of the USSs may be received from an application unit, the application unit being an application unit selected from the group of application units consisting of: a USS, a UAS Traffic Management module, the UAV, the UAV-C, a UAS application specific server, and a UAS operator. The method may further comprise receiving Application Function Service identities and DNAIs for each of the plurality of USS networks.

The information specifying the service area of a USS comprises one or more of the group consisting of: information specifying a geographical extent for the service supplied by that USS; information specifying a geographical extent for the service supplied by that USS within a registration area of the UAV; information specifying a time period during which a service is supplied by that USS; information specifying a time period during which a service is supplied by that USS within a registration area of the UAV; and information specifying a network topology for that USS.

The extent of the USS network may be defined by a geographical area and the airspace above that geographical area. The geographical extent of a USS network may be defined by location coordinates such as GPS coordinates. The geographical extent of a USS network may be defined by one or more cell service areas of a wireless communications network. At least one of the USS networks for which the geographical extent and time validity is transmitted to the configuration unit is an initial USS network. The initial USS network is the network that the UAV communicates with at take-off. The plurality of the USS networks may be defined by a Local USS Network (LUN).

The method may further comprise configuring a plurality of user-plane communication paths for the UAS, the configuration based on the determined mapping of the UAS to the plurality of USSs and the information specifying the service areas of the USSs, wherein each user-plane communication path comprises a Data Network Access Identifier, DNAI. Such configuration of user-plane communication paths tends to facilitate improved handover between USSs of the UAV in flight.

The method may further comprise configuring one or more policies for the UAS based on the mapping of the UAS to the plurality of USSs and the information specifying the service areas of the USSs, wherein the one or more policies comprise one or more policies selected from the group of policies consisting of USS switching criteria, priorities for the USSs having overlapping service areas, and a primary USS for the UAS. The method may further comprise transmitting the one or more policies to the UAS and/or a control function of the communication network. The control function can be, for example, any network function of the 5G core network control plane as defined in 3GPP TS 23.501 v 17.2.0).

The method may further comprise transmitting the determined mapping to one or more network functions of the communication network and/or the UAS.

The determination of the mapping of the UAS to the plurality of USSs may be based on a planned and/or expected route of the UAV. The route of the UAV may be defined by a flight plan. The expected route of the UAV may comprise a window of operations within which the flight of the UAV is expected to be constrained.

The plurality of USSs may comprise one or more Local USS Networks, LUNs.

The method may further comprise using the service area of the USS networks to detect a trigger event for initiating a change of USS, and responsive to detecting the trigger event, when the UAV is communicating with a first USS, determining whether a second USS is available to provide a service to the UAV; and, responsive to determining that the second USS is available to provide a service to the UAV, sending a request for UAV handover to the second USS network.

The trigger event may comprise the current location of the UAV meeting a location criterion. The location criterion may comprise the UAV location coinciding with a boundary zone at the edge of the geographical extent of the USS network. The location criterion may comprise the UAV detecting signals from a base station of a cell outside of the geographical extent of the USS network. The trigger event may comprise a signal strength of a wireless communications signal in a USS in use dropping below a signal strength threshold, or packet loss for such a signal exceeding a packet loss threshold.

The configuration unit may detect the trigger event. The trigger event may be detected by the UAV or by the UAV Controller and a request sent to the configuration unit.

The method may further comprise transmitting a command to the UAS, the command being a command to migrate to receiving one or more services from the second USS network. The UAS may migrate or be migrated to receiving one or more services from the second USS network, instead of or in addition to from the first USS, in response to receiving the command. The method may further comprise receiving confirmation that the UAV has handed over to the second USS network.

The configuration unit may be a unit selected from the group of units consisting of: an Uncrewed Aerial System Application Enabler Server (UAES), the UAES being a server that is remote from the UAS; the UAV-C; a Network Exposure Function; a Network Function; an Application Function; a Service Capability Exposure Function; and the UAV.

There is further provided a configuration unit, for communicating with a communication network and an Uncrewed Aerial System, UAS, the UAS including an Uncrewed Aerial Vehicle, UAV, the configuration unit comprising a receiver and a processor. The receiver is arranged to receive, for each of a plurality of UAV service suppliers, USS, information specifying a service area of that USS. The processor is arranged to obtain UAS specific information, wherein the UAS specific information comprises a UAV registration area, a USS service requirement, or a combination thereof; and determine a mapping of the UAS to (one or more of) the plurality of USSs based on the received USS information and the obtained UAS information. The configuration unit may be embodied as a network node 800.

There is further provided a system comprising a configuration unit as described herein and an application unit. The configuration unit is arranged to receive the information specifying the service areas of the USSs from the application unit. The application unit is an application unit selected from the group of application units consisting of a USS, a UAS Traffic Management module, the UAV, the UAV-C, a UAS application specific server, and a UAS operator.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a configuration unit, the configuration unit being communicatively coupled to a communication network and an Uncrewed Aerial System (UAS) the UAS including an Uncrewed Aerial Vehicle (UAV) and a UAV controller (UAV-C), the method comprising:
receiving, for each of a plurality of UAV service suppliers (USS), information specifying a service area of that USS;
obtaining UAS specific information, wherein the UAS specific information comprises a UAV registration area, a USS service requirement, or a combination thereof; and
determining a mapping of the UAS specific information to one or more of the plurality of USSs based on the received USS information and the obtained UAS specific information.

2. The method of claim 1, wherein determining the mapping comprises selecting one or more of the plurality of USSs to supply one or more services specified by the USS service requirement to the UAV as the UAV flies within the UAV registration area, the selecting based upon the received USS information and the obtained UAS specific information.

3. The method of claim 1, wherein the information specifying the service areas of the USSs is received from an application unit, the application unit being an application unit selected from the group of application units consisting of: a USS, a UAS Traffic Management module, the UAV, the UAV-C, a UAS application specific server, and a UAS operator.

4. The method of claim 1, wherein the information specifying the service area of a USS comprises one or more of the group consisting of:
information specifying a geographical extent for the service supplied by that USS;
information specifying a geographical extent for the service supplied by that USS within a registration area of the UAV information specifying a time period during which a service is supplied by that USS;
information specifying a time period during which a service is supplied by that USS within a registration area of the UAV; and
information specifying a network topology for that USS.

5. The method of claim 1, further comprising configuring a plurality of user-plane communication paths for the UAS, based on the determined mapping of the UAS to the plurality of USSs and the information specifying the service areas of the plurality of USSs, wherein each user-plane communication path comprises a Data Network Access Identifier (DNAI).

6. The method of claim 1, further comprising:
configuring one or more policies for the UAS based on the mapping of the UAS to the plurality of USSs and the information specifying the service areas of the USSs, wherein the one or more policies comprise one or more policies selected from the group of policies consisting of USS switching criteria, priorities for the USSs having overlapping service areas, and a primary USS for the UAS; and
transmitting the one or more policies to the UAS or a control function of the communication network, or both.

7. The method of claim 1, further comprising transmitting the determined mapping to one or more network functions of the communication network or the UAS, or both.

8. The method of claim 1, wherein the determination of the mapping of the UAS to the plurality of USSs is based on a planned route of the UAV or an expected route of the UAV, or both.

9. The method of claim 1, wherein the plurality of USSs comprise one or more Local USS Networks (LUNs).

10. The method of claim 1, further comprising:
using the service area of the USS to detect a trigger event for initiating a change of USS;
responsive to detecting of the trigger event, when the UAV is communicating with a first USS, determining whether a second USS is available to provide a service to the UAV; and
responsive to determining that the second USS is available to provide a service to the UAV, sending a request for UAV handover to the second USS.

11. The method of claim 10, further comprising transmitting a command to the UAS, the command being a command to migrate to receiving one or more services from the second USS.

12. The method of claim 10, further comprising receiving a confirmation that the UAV has handed over to the second USS.

13. The method of claim 1, wherein the configuration unit is a unit selected from the group of units consisting of:
an Uncrewed Aerial System Application Enabler Server (UAES), the UAES being a server that is remote from the UAS;
the UAV-C;
a Network Exposure Function (NEF);
a Network Function (NF);
an Application Function (AF);
a Service Capability Exposure Function (SCEF); and
the UAV.

14. A configuration unit for communicating with a communication network and an Uncrewed Aerial System (UAS), the UAS including an Uncrewed Aerial Vehicle (UAV) and a UAV controller (UAV-C), the configuration unit comprising:
at least one memory; and at least one processor coupled with the at least one memory and configured to cause the configuration unit to:
receive, for each of a plurality of UAV service suppliers (USS), information specifying a service area of that USS;
obtain UAS specific information, wherein the UAS specific information comprises a UAV registration area, a USS service requirement, or a combination thereof; and
determine a mapping of the UAS specific information to one or more of the plurality of USSs based on the received USS information and the obtained UAS specific information.

15. A system comprising:
a configuration unit for communicating with a communication network and an Uncrewed Aerial System (UAS) comprising an Uncrewed Aerial Vehicle (UAV) and a UAV controller (UAV-C); and
an application unit; wherein
the configuration unit is arranged to:
receive, for each of a plurality of UAV service suppliers (USS), information specifying a service area of a respective USS from the application unit;
obtain UAS specific information, wherein the UAS specific information comprises a UAV registration area, a USS service requirement, or a combination thereof; and
determine a mapping of the UAS specific information to one or more of the plurality of USSs based on the USS information and the UAS specific information; and
wherein the application unit is an application unit selected from the group of application units consisting of a USS, a UAS Traffic Management module, the UAV, the UAV-C, a UAS application specific server, and a UAS operator.
